(19) United States
(12) Patent Application Publication
(10) Pub. No.: US 2015/0205541 A1
(43) Pub. Date: Jul. 23, 2015

(54) HIGH-CAPACITY SOLID STATE DISK DRIVES

(71) Applicant: Samya Systems, Inc., Santa Clara, CA (US)

(72) Inventors: Satyanarayana Nishtala, Santa Clara, CA (US); Thomas Lee Lyon, Santa Clara, CA (US)

(21) Appl. No.: 14/598,662

(22) Filed: Jan. 16, 2015

Related U.S. Application Data
(60) Provisional application No. 61/929,223, filed on Jan. 20, 2014.

(51) Int. Cl. G06F 3/06

(52) U.S. Cl. CPC G06F 3/0634; G06F 3/0614; G06F 3/0683

(57) ABSTRACT

Data storage devices are disclosed. A plurality of memory controllers are operatively coupled to a plurality of solid state memory devices. The plurality of memory controllers are configured to access data stored by the plurality of solid state memory devices. A first selection circuit is operatively coupled to the plurality of memory controllers. The first selection circuit is configured to activate each of the plurality of memory controllers selectively. A drive body includes the plurality of solid state memory devices, the plurality of memory controllers. The drive body further includes an interface operatively coupled to the selection circuit. The interface receives signals that cause the first selection circuit to activate a selected memory controller.

### PRIORITY CLAIM UNDER 35 USC 119(E)

The present application claims the benefit under 35 U.S.C. 119(e) of U.S. Provisional Patent Application Ser. No. 61/929,223, filed Jan. 20, 2014, titled “HIGH-CAPACITY Solid State Disk Drives,” which is incorporated herein by reference in its entirety.

### FIELD

This application relates generally to data storage, and more specifically, to solid state drives.

### BACKGROUND

A solid-state disk (SSD) includes integrated circuits to store data electronically rather than using a rotating magnetic disk platter and/or moveable read/write heads. In this way, SSDs do not really on mechanical parts to store, read, and write data. As a result, SSDs can be more resistant to damage, have a longer life expectancy, as well as improved performance in terms of having a lower access time and less latency.

### BRIEF DESCRIPTION OF THE DRAWINGS

In the drawings, which are not necessarily drawn to scale, like numerals may describe similar components. Like numerals having different letter suffixes may represent different instances of similar components. The drawings illustrate generally, by way of example, but not by way of limitation, various example embodiments discussed in the present document.

FIG. 1 is a network diagram depicting a client-server system, in accordance with an example embodiment.

FIG. 2 is a schematic block diagram of an SSD device, in accordance with an example embodiment, included in the system of FIG. 1.

FIG. 3 is a schematic block diagram of an SSD device, in accordance with an example embodiment, that may be included in the system of FIG. 1.

FIG. 4 is a schematic block diagram of an SSD device, in accordance with an example embodiment, that may be included in the system of FIG. 1.

FIG. 5 is a schematic layout diagram of an SSD device, in accordance with an example embodiment, that may be included in the system of FIG. 1.

FIG. 6 is a schematic layout diagram of a parent board, in accordance with an example embodiment, of an SSD device.

FIG. 7 is a schematic layout diagram of a daughter board, in accordance with an example embodiment, of an SSD device.

FIG. 8 is a schematic block diagram illustrating an example embodiment of signal connections between the parent board and the daughter boards of the SSD device of FIG. 5.

### DETAILED DESCRIPTION

Example methods and systems to store electronic data are described. In the following description, for purposes of explanation, numerous specific details are set forth in order to provide a thorough understanding of example embodiments. It will be evident, however, to one skilled in the art that the present invention may be practiced without these specific details.

Example embodiments are described in the context of systems and methods that include serial attached small computer system interface (SAS), serial ADVANCED TECHNOLOGY attachment (SATA), and/or peripheral component interconnect express (PCIe) protocols, interfaces and devices, but will be applicable to other types of protocols, interfaces, and devices. By way of non-limiting, non-exhaustive examples, SAS can include point-to-point serial protocols for communicating data; SATA can include computer bus protocols for interoperable connections of a bus adapter to a data storage device; PCIe can include serial expansion protocols. These protocols, as well as related interfaces and devices, can be used to connect an electronic computing device, such as a server, to a data storage devices, such as one or more solid-state drive (SSD) device, among other types of devices.

In one example embodiment, an SSD device is described for providing high-capacity data storage. For example, certain example embodiments can provide a substantial increase in capacity per unit volume compared to hard disk drive (HDD) technology. In particular, the SSD device can utilize NAND flash memory in a large form factor (LFF) drive body, as well as other form factors, for providing read-intensive data access. Furthermore, read-intensive data access is a characteristic of Big Data application, where data is infrequently updated once the data is stored in the SSD device of the Big Data application. In other words, Big Data applications read data at a higher rate than it writes data. In non-limiting examples, some Big Data applications can have write rates of less than about 5% of the total data accesses (e.g., reads and writes) over a given period. Other Big Data applications can have write rates of less than about 20% or less than about 25% of the total data accesses. Accordingly, in terms of read rates, various Big Data applications can have read rates of greater than about 75%, 80%, or 95%. In contrast, enterprise data storage and transaction data storage applications can typically have write rates of about 30% to about 40% of the data access as data writes.

Data reads can consume less power and generate less heat than data writes do. In this way, the SSD device targeted to read intensive applications can generate reduced amounts of heat and can utilize reduced data management overhead (e.g., with respect to wear levelling and garbage collection) as compared to SSDs targeted to write-intensive applications. Accordingly, the SSD device can include an increased number of memory chips in a given drive body, resulting increased capacity of memory while meeting operational constraints (e.g., thermal constraints) of the SSD device. Additionally, in some example embodiments, the SSD device can utilize a higher percentage of the available storage capacity for data storage and allocate a much smaller percentage of capacity for data reliability management (e.g., wear levelling).

In one example embodiment, the SSD device can provide data access (e.g., reads and/or writes) for Big Data applications that require substantially fewer data writes than, for instance, enterprise data storage. By way of example, Big Data applications can include applications involving data sets of about 100 TB to about 900 petabytes or greater. Additionally or alternatively, example Big Data applications can include applications that access data in large blocks, such as about 64 kilobytes to about 64 megabytes or greater. In contrast, example enterprise applications can access data in blocks of about 4 kilobyte. Additionally or alternatively, as stated, example Big Data applications can include applications that have a read-write ratio of about 95:5 to about 100:0 (e.g., a read rate greater than about 95% or a write rate of less than about 5% of the total data access). Other example Big Data applications can include applications that have a read-write ratios in the range of about 85:15 to about 100:0, or in the range of about 80:20 to about 100:0, for a given period. In contrast, example enterprise applications can include applications that have a read-write ratio of about 60:40, or about 70:30, of 4 kilobyte blocks over a given period.

In at least these ways, Big Data applications perform read-intensive operations. Accordingly, some example embodiments of the SSD devices disclosed herein can provide high-density data storage for read-intensive applications such as, but is not limited to, Big Data applications. In one example embodiment, an SSD device can provide more than about five times data capacity per unit volume as compared to HDD technology.

Accordingly, some example embodiments of SSD devices disclosed herein can provide one or more of various features. For example, the SSD devices can provide improvements in performance, power (temperature) management, or failure resiliency, among others, compared to an HDD. These features can be desirable for Big Data applications. Additionally, it will be appreciated that future improvements in flash memory technologies can increase the capacity advantage of various SSD devices disclosed herein as compared to HDD devices.

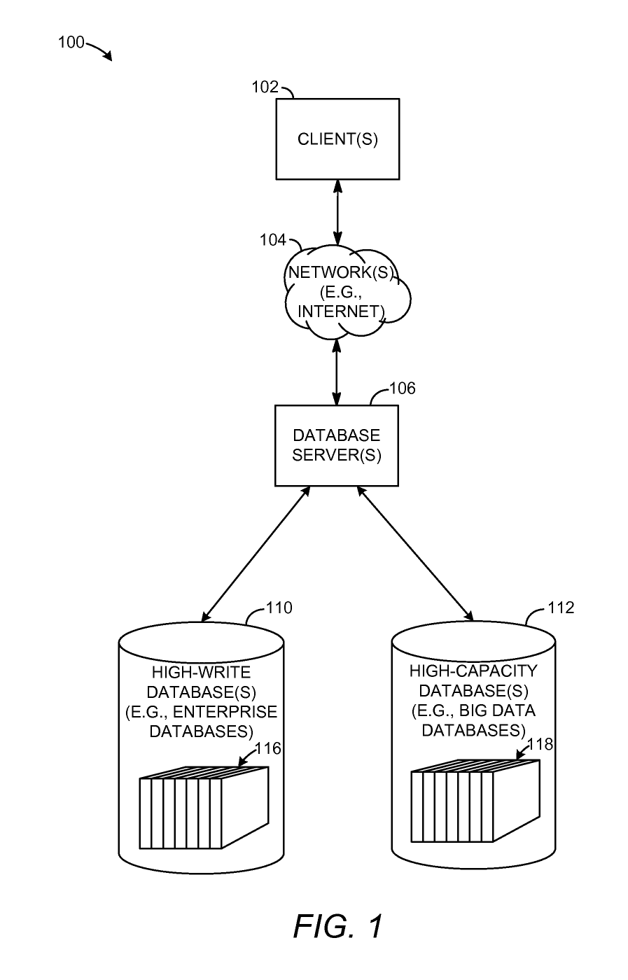

FIG. 1 is a network diagram depicting a client-server system 100, in accordance with an example embodiment. The client-server system 100 includes one or more client machines 102 interconnected to a network 104 and one or more servers 106. The server 106, in the example, forms of a network-based system utilizing various data storage devices. In the illustrated example embodiment, the server 106 is interconnected to a high-write database 110 and to a high-capacity database 112. The high-write database 110 can include one or more disk drives 116, and the high-capacity database 112 can include one or more disk drives 118. The server 106 can provide server-side functionality, via a network 104 (e.g., the Internet or Wide Area Network (WAN)) to one or more clients, such as the client machine 102

While the system 100 shown in FIG. 1 employs a client-server architecture, the present disclosure is of course not limited to such an architecture, and could equally well find application in a distributed, or peer-to-peer, architecture system, for example. The various applications of the server 106 could also be implemented as standalone software programs, which do not necessarily have networking capabilities.

The high-write database 110 can serve to provide write-intensive data access. For example, the high-write database 110 can support one or more transactional enterprise database applications. The high-capacity database 112 can serve to provide read-intensive data access. For example, the high-capacity database 112 can support one or more Big Data applications. Accordingly, the disk drives 116, 118 can correspond to different types of disk drives selected based on the application.

For example, in the illustrated example embodiment, the disk drives 116 can correspond to small for factor (SFF) (e.g., 2.5 inch disk drives) HDDs and/or SSDs that are used as a storage medium for enterprise applications. SFF HDDs can offer low seek latency, high performance needed for transactional database processing. Regarding Big Data applications, however, the demands on installed capacity can make it desirable to improve the installable storage capacity in a given data center, even faster than capacity growth trends based on HDD technology.

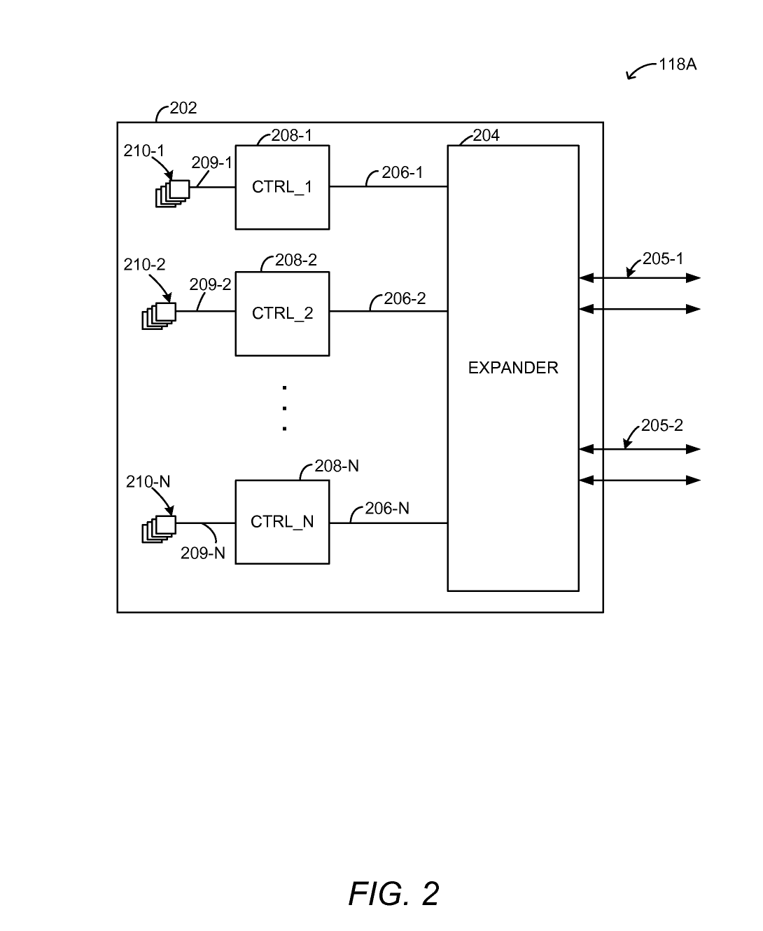

Accordingly, in the illustrated example embodiment, the disk drives 118 can correspond to SSD devices (installed, for example, in a storage array like a JBOD (just-a-bunch-disks) device) described in further detail below in connection with the FIGS. 2-8. The SSD devices 118 can provide high-density, read intensive data storage medium for Big Data applications, among other types of applications.

### Example SSD Device Architectures

FIG. 2 is a schematic block diagram of an SSD device 118A, in accordance with an example embodiment, included in the system 100 of FIG. 1. The SSD device 118A comprises a drive body 202, a SAS expander 204, SAS ports 205-1, 205-2, one or more non-volatile memory controllers 208-1, 208-2, . . . , 208-N, and one or more groups of non-volatile memory chips 210-1, 210-2, . . . , 210-N. The SSD device 118A further includes lines 206-1, 206-2, . . . , 206-N, 209-1, 209-2, . . . , 209-N. The SSD device 118A, can for example, be based on non-volatile memory technologies, such as NAND Flash technology. However, it will be appreciated by a person skilled in the art that the SSD device 118A can include other types of SSD technologies. Additionally, the groups of memory chips 210-1, 210-2, . . . , 210-N do not necessarily include equal amounts of memory chips and/or equal amounts of data storage capacity. Furthermore, the SSD device 118A can include addition memory chips that are not shown.

The drive body 202 can be configured to encompass, enclose, and/or house one or more elements of the SSD device 118A. The drive body 202 can be defined in the form factor of an LFF drive. The illustrated drive body 202 of FIG. 2, for example, houses the SAS expander 204, the memory controllers 208-1, 208-2, . . . , 208-N, and the memory chips. In addition, the drive body 202, via the SAS expander 204, can provide SAS ports 205-1, 205-2 externally to the drive body 202 to interface with a device, such as the server 106 of FIG. 1. In the illustrated example embodiment, the SAS port 205-1 can correspond to a two lane wide SAS port of 12 gigabits per second (Gb/s), and similarly, the SAS port 205-2 can correspond to a second two lane wide SAS port of 12 Gb/s SAS.

The drive body 202 can have a form factor suitable for mounting to a rack, drive bay, and/or other suitable mounting assembly. As stated, in one example embodiment, the drive body 202 has a form factor substantially conforming to the form factor of an LFF drive (e.g., 3.5 inch disk drive). For example, the drive body 202 can form an external shape defining dimensions of about 4 inches wide by about 1 inch high.

Although the drive body 202 was discussed above in the context of an LFF disk drive, it will be appreciated that the drive body 202 can be defined in other form factors, such as dimensions substantially similar to a small form factor (SFF) drive (e.g., 2.5 inch disk drives). It will be appreciated that other types of form factor scan be selected that are suitable for enclosing the components of the SSD device 118A and for interfacing with a separate (host) device.

In one example embodiment, the SAS Ports 205-1, 205-2 can correspond to or use Multi-Link SAS or SFF-8639 connector(s). Multi-Link SAS defines a backward compatible extension of a SAS connector. In particular, a Multi-Link SAS connector can support two 12 Gb/s SAS ports of two lanes each, or two PCIe Gen3 ports of two lanes each. In addition, Multi-Link SAS can add a multi-master serial single-ended computer bus, such as an I²C interface. Although, it will be appreciated by one skilled in the art that other types of ports can be used, such as, but is not limited to, one or two ports of a single lane each.

The SAS expander 204 can be configured to provide connections of the SAS ports 205-1, 205-2 selectively to the plurality of memory controllers 208-1, 208-2, . . . , 208-N. For example, the illustrated SAS expander 204 is operatively coupled to the SAS ports 205-1, 205-2 at a first side to receive and/or provide signals (e.g., SAS signals), and is operatively coupled to the memory controllers 208-1, 208-2, . . . , 208-N at a second side via lines 206-1, 206-2, . . . , 206-2 to provide or receive signals (e.g., SAS and/or SATA signals). Herein, “side” can refer to a side of a conceptual interface of the SAS expander 204, such as a first side corresponding to the external interface of the SSD device 118A and a second side corresponding to the expander-controller interface, and “side” does not necessarily refer to a physical side of the SAS expander 204 device. During operation, the SAS expander 204 can be configured to connect a port (e.g., the SAS port 205-1 and/or the SAS port 205-2) to a selected controller of a plurality of memory controllers (e.g., a selected one of the memory controllers 208-1, 208-2, . . . , 208-N) for communicating signals. For example, the SAS expander 204 can be configured to operatively couple to a SAS controller in a server (not shown) via SAS ports 205-1, 205-2. The SAS expander 204 can determine the selection of the memory controller based on the signals of the SAS ports 205-1, 205-2. In one example embodiment, the SAS expander 204 can activate the selected memory controller to perform the read and/or write operations.

The one or more memory controllers 208-1, 208-2, . . . , 208-N can be configured to control the flow of data going to and from the memory chips 210-1, 210-2, . . . , 210-N. In the illustrated example embodiment, the memory controllers 208-1, 208-2, . . . , 208-N are operatively coupled to memory chips 210-1, 210-2, . . . , 210-N, respectively, via lines 209-1, 209-2, . . . , 209-N. Each of the memory controllers 208-1, 208-2, . . . , 208-N can correspond to a digital circuit, such as, but is not limited to, an ASIC. In one example embodiment, the memory controllers can correspond to a flash memory controller. The memory chips 210-1, 210-2, . . . , 210-N can correspond to flash memory, such as, but is not limited to, NAND-type flash memory and/or Re-RAM-type memory.

The complexity and size of the memory controllers 208-1, 208-2, . . . , 208-N can determine, at least partially, the number of memory chips that can be interfaced with each memory controller 208-1, 208-2, . . . , 208-N. In turn, the total number of memory chips 210-1, 210-2, . . . , 210-N that can be interfaced with the memory controllers 208-1, 208-2, . . . , 208-N can determine the capacity of the SSD device 118A. However, the complexity and size of each the memory controllers 208-1, 208-2, . . . , 208-N can be constrained by technology, cost, efficiency, performance, power consumption, and the like factors, as stated above. Accordingly, the amount of memory provided by a memory controller can be constrained. For example, in one example embodiment, the memory controllers 208-1, 208-2, . . . , 208-N can each support up to about 2 TB of flash memory.

Accordingly, the illustrated example embodiment can increase data capacity of SSD devices by including a plurality of memory controllers 208-1, 208-2, . . . , 208-N within the drive body 202. As stated, the memory controllers 208-1, 208-2, . . . , 208-N can be operatively coupled to the SAS expander 204 to provide a common external interface, as shown in FIG. 2. The SAS expander 204 can be coupled to an SSD drive controller (not shown). Furthermore, the plurality of memory controllers 208-1, 208-2, . . . , 208-N together can support more memory chips than what can be achievable by a single memory controller. Accordingly, in one example embodiment, the SSD device 118A can provide increased data storage capacity by coupling the SAS expander 204 to the plurality of memory controllers 208-1, 208-2, . . . , 208-N, each coupled to a set of memory chips 210-1, 210-2, . . . , 210-N.

In one aspect of some example embodiments described herein, a large number of memory chips can be included inside the drive body 202. For example, in one example embodiment, the SSD device can include 16 memory controllers and 216 memory chips that together provide about 27 TB of total data storage. It will be appreciated by one skilled in the art that any suitable number of memory controllers and memory chips can be used. The total number of memory controllers and memory chips that can be packaged in the SSD device 118 can be determined based at least on the mechanical packaging limits (e.g., form factor), thermal limits and budgets, and other operational and design considerations. For example, too few memory chips may not provide sufficient capacity for its application. Too many memory chips may not provide sufficient failure protection for its applications—e.g., as the size of the device increases, replacing the drive will result in replacing larger capacity data storage, which may result in an increased amount of time to recover from a drive failure or drive replacement.

In one way, the SSD device 118A can include a large number of memory chips (or a large amount of data storage) for a given volume (defined, for example, by the drive body 202) because, for example, the SSD device 118A can be configured to provide read-intensive data storage, such as, data storage for big data applications. This is because one factor that can limit the data storage capacity of an SSD device is the threshold power rating (“power budget” or “thermal budget”) defined by a threshold write input-output (10) rate of the SSD drive 118A. As stated, power consumption, and the heat generated therefrom, can be about an order of magnitude lower for reads compared to writes. Accordingly, for a given threshold power rating, the SSD device 118A can include a comparatively greater number of memory chips/data storage than what can be included in a device providing non-read-intensive data access (e.g., an SSD for enterprise data storage).

In another aspect of some example embodiments described herein, read-intensive data storage of the SSD 118A can also provide reduced wear levelling of flash memory. That is, the memory controllers 208-1, 208-2, . . . , 208-N can reserve a certain amount of flash memory capacity for wear leveling—e.g., a process of distributing erasures and re-writes approximately evenly over the flash memory device. The amount can be based on a predetermined threshold number of writes to the SSD device 118A over its lifetime. Read intensive SSD devices 118A, therefore, can provide more of the installed flash capacity as data storage rather than reserved for wear levelling. In one example, the SSD device 118A can reserve less than about 5% of the total flash capacity of the memory chips for wear levelling, and can provide support for about 95:5 read-write ratio. Alternatively, about 28% of memory capacity may be reserved for wear levelling to support a 60:40 read-write ratio. Utilizing a reduced amount of storage for wear levelling can enable higher usable capacity with a similar number of flash devices.

In another aspect of some example embodiments described herein, the read-intensive data storage of the SSD 118A can also provide data storage without using a SuperCap backed memory that can be used in, for example, enterprise SSD devices to hide the write latency of NAND flash memory. A SuperCap (not shown) is a device that can serve as a battery backup unit by utilizing capacitors to maintain a voltage charge for the memory device. SuperCap devices can be omitted in some example embodiments because in read-intense environments, such as Big Data applications, writes to the drives can be infrequent and may not be performance critical. In some example embodiments, a host system based on non-volatile random-access memory (NVRAM) storage can be used to mitigate write latency issues.

In another aspect of some example embodiments described herein, the SSD device 118A can provide improved failure resiliency by including a plurality of memory chips 210-1, 210-2, . . . , 210-N and a plurality of memory controllers 208-1, 208-2, . . . , 208-N. For example, each memory controller 208-1, 208-2, . . . , 208-N can provide a failure resiliency mechanism to survive one or more memory chip failures. In particular, the memory controller 208-1 can be configured to accommodate failures of one or more of the memory chips 210-1, 210-2, . . . , 210-N based on detecting a failure of one of the memory chips 210-1, 210-2, . . . , 210-N and by redistributing data storage across the remaining operational memory chips. Furthermore, the SSD device 118A can also accommodate failures of one or more of the memory controllers 208-1, 208-2, . . . , 208-N. For example, if the SAS expander 204 detects a failure of the memory controller 208-1 (or any other of the memory controllers 208-2, . . . , 208-N), the SSD device 118A (e.g., via the SAS expander 204) can provide a signal at one of the SAS ports 205-1, 205-2 to provide an indication of a failure. A host device can receive the signal indicating the failure and can take alternative recovery actions for the fraction of storage that has failed. However, the remaining portion of the SSD device 118A can be functional and still provide data storage to the host device. In contrast, an SSD device having but one memory controller can fail if that one memory controller fails. Accordingly, regarding SSD device 118A, failure of any one of the memory controllers 208-1, 208-2, . . . , 208-N may not cause a complete drive failure.

Another aspect of some example embodiments described herein is improved power management resolution. For example, the memory controllers 208-1, 208-2, . . . , 208-N can be configured to enter an active state when they are reading or writing data or when performing management functions, such as garbage collection. Otherwise, the memory controllers 210-1, 210-2, . . . , 210-N enter a low power or inactive state. In some example embodiments, the inactive power can be about 1/20th of the power of an active memory controller. In contrast, if the SSD device 118A consisted of only one memory controller, then the resolution of power management the entire SSD device 118A. However, the SSD device 118A can comprise a plurality of memory controllers 208-1, 208-2, . . . , 208-N. The SSD device 118A can provide finer resolution in power management by being configured to set each of the memory controllers 208-1, 208-2, . . . , 208-N in a low power mode if the corresponding memory controller is inactive.

Furthermore, the SSD device 118A, or portions thereof, can be powered down via the SAS ports 205-1, 205-2. For example, in one example embodiment, the SSD device 118A can be powered down via an I²C interface on the multi-link SAS connector of the SSD device 118A. The power down signal can be received by the SAS expander 204, which can be configured to power down the memory controllers 208-1, 208-2, . . . , 208-N and the memory chips 210-1, 210-2, . . . , 210-N. This interface can be used to power down the SSD device 118A when the device is not being used. Power-down functionality can be useful in, e.g., Big Data applications that include hundreds to thousands of drives in a given installation, and a substantial number of the drives are not accessed for substantial durations. In some example embodiments, the SSD device 118A can be configured to power up in less than 5 milliseconds, which can be less than the seek time of some HDDs. Therefore, the SSD device 118A can be configured to be powered up when being accessed, and can be powered down otherwise.

Yet another aspect of some example embodiments described herein is improved temperature management. For example, the finer resolution of power management of the SSD device 118A can provide finer control of the temperature of the SSD deice 118A, for example, in order to provide improved performance while satisfying a given thermal budgets.

Additionally, each of the memory controllers 208-1, 208-2, . . . , 208-N can be configured to selectively allow or inhibit data access (e.g., data writes) to the memory chips 210-1, 210-2, . . . , 210-N based on a write-rate threshold. For example, in one example embodiment, the memory controllers 208-1, 208-2, . . . , 208-N can be configured to record information indicative of data writes performed by the respective memory controller. In one example embodiment, each of the memory controllers 208-1, 208-2, . . . , 208-N can record or track the number of data writes performed by the respective memory controller and/or the number of the data writes to particular memory chips 210-1, 210-2, . . . , 210-N, for example, over a given period of time. Accordingly, each of the memory controllers 208-1, 208-2, . . . , 208-N can be configured to compare the record of the number of data writes to a predetermined threshold, and allow data writes if the number of data writes does not exceed the threshold. Otherwise, each of the memory controllers 208-1, 208-2, . . . , 208-N can be configured to inhibit data writes if the threshold is exceeded.

Additionally or alternatively, each of the memory controllers 208-1, 208-2, . . . , 208-N can be configured to selectively allow or inhibit data access (e.g., data writes) to the memory chips 210-1, 210-2, . . . , 210-N based on a temperature of the SSD device 118A. For example, in one example embodiment, the memory controllers 208-1, 208-2, . . . , 208-N can be configured to sense its temperature. Accordingly, the memory controllers 208-1, 208-2, . . . , 208-N can be configured to compare the respective sensed temperatures against a threshold, and allow data writes if the respective sensed temperature does not exceed the threshold. Otherwise, the memory controllers 208-1, 208-2, . . . , 208-N may inhibit data writes if the respective sensed temperature is greater than the threshold.

Additionally or alternatively, each of the memory controllers 208-1, 208-2, . . . , 208-N can be configured to selectively allow or inhibit data access (e.g., data writes) to the memory chips 210-1, 210-2, . . . , 210-N based on an estimated temperature of the SSD device 118A. For example, in one example embodiment, the memory controllers 208-1, 208-2, . . . , 208-N can be configured to determine or estimate a temperature of one or more of the plurality of memory chips 210-1, 210-2, . . . , 210-N. Temperatures can be determined or estimated based at least on a number of data accesses to the memory chips 210-1, 210-2, . . . , 210-N. For example, the memory controllers 208-1, 208-2, . . . , 208-N can be configured to track the number of data writes to each of the memory chips 210-1, 210-2, . . . , 210-N. In one example embodiment, the number of data writes to a particular memory chip over a period of time can be used to estimate the temperature of the particular memory chip. Accordingly, the memory controllers 208-1, 208-2, . . . , 208-N can be configured to compare the estimated temperature against a threshold, and allow data writes to the particular memory chip if the estimated temperature does not exceed the threshold. Otherwise, the memory controllers 208-1, 208-2, . . . , 208-N may inhibit data writes to the particular memory chip if the estimated temperature is greater than the threshold.

### Dual Expander SSD Example Embodiment

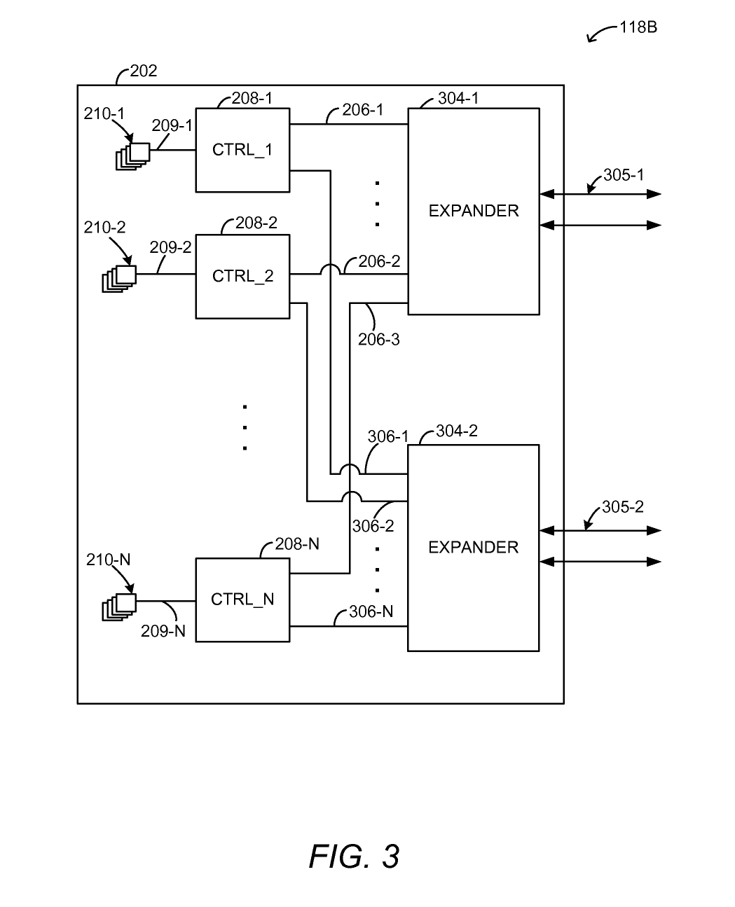

FIG. 3 is a schematic block diagram of an SSD device 118B, in accordance with an example embodiment, that may be included in the system 100 of FIG. 1. In particular, FIG. 3 illustrates an example embodiment that includes dual SAS expanders. Elements common to FIGS. 2 and 3 share common reference indicia, and only differences between the Figures are described herein for the sake of brevity.

The SSD device 118B comprises a drive body 202, SAS expanders 304-1, 304-2, SAS ports 305-1, 305-2, one or more memory controllers 208-1, 208-2, . . . , 208-N, and one or more groups of memory chips 210-1, 210-2, . . . , 210-N. The SSD device 118B further includes lines 206-1, 206-2, . . . , 206-N, 209-1, 209-2, . . . , 209-N, 306-1, 306-2, . . . , 306-N.

The SAS expanders 304-1, 304-2 can each be configured to provide connections of the SAS ports 305-1, 305-2 selectively to the plurality of memory controllers 208-1, 208-2, . . . , 208-N. For example, the illustrated SAS expander 304-1 is operatively coupled to the SAS port 305-1 at a first side to receive and/or provide signals (e.g., SAS signals), and is operatively coupled to the memory controllers 208-1, 208-2, . . . , 208-N at a second side via lines 206-1, 206-2, . . . , 206-N to provide or receive signals (e.g., SAS and/or SATA signals). Furthermore, the illustrated SAS expander 304-2 is operatively coupled to the SAS port 305-2 at a first side to receive and/or provide signals (e.g., SAS signals), and is operatively coupled to the memory controllers 208-1, 208-2, . . . , 208-N at a second side via lines 306-1, 306-2, . . . , 306-N to provide or receive signals (e.g., SAS and/or SATA signals). Accordingly, during operation, each of the SAS expanders 304-1, 304-2 can be configured to connect a respective port (e.g., the first port formed by the SAS port 305-1 and corresponding to SAS expander 304-1, and the second port formed by the SAS port 305-2 and corresponding to SAS expander 304-2) to a selected controller of a plurality of memory controllers (e.g., a selected one of the memory controllers 208-1, 208-2, . . . , 208-N) for communicating signals. Each of the SAS expanders 304-1, 304-2 can determine the selection of the memory controller based on the respective signals of the SAS ports 305-1, 305-2. In one example embodiment, the SAS expanders 304-1, 304-2 can activate the selected memory controller to perform the read and/or write operations.

The illustrated memory controllers 208-1, . . . , 208-N can be configured to support dual port SAS. For example, each controller of the illustrated the memory controllers 208-1, . . . , 208-N can receive a first SAS input 206-1, 206-2, . . . , 206-N from the first SAS expander 304-1 and a second SAS input 306-1, 306-2, . . . , 306-N from the second SAS expander 304-2. One advantage, among others, of some example embodiments is that including two or more SAS expanders 304-1, 304-2 can increase robustness to failures. Total drive failure due to a SAS expander failure can be mitigated if the memory controllers 208-1, . . . , 208-N support dual port SAS. In such a case, two expanders 304-1, 304-2 can be used, as shown, to offer two independent paths to the memory controllers 208-1, . . . , 208-N, as shown in FIG. 3.

### Dual PCIe SSD Example Embodiment

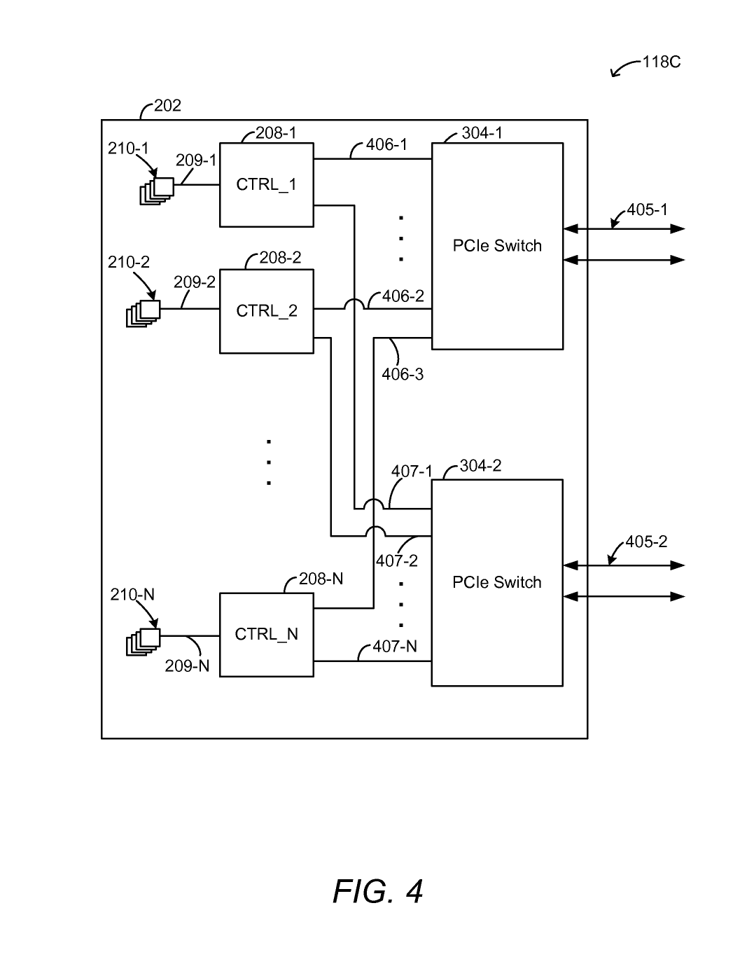

FIG. 4 is a schematic block diagram of an SSD device 118C, in accordance with an example embodiment, that may be included in the system 100 of FIG. 1. In particular, FIG. 4 illustrates an example dual PCIe embodiment. Elements common to FIGS. 3 and 4 share common reference indicia, and only differences between the Figures are described herein for the sake of brevity.

The SSD device 118C comprises a drive body 202, PCIe switches 404-1, 404-2, PCIe ports 405-1, 405-2, one or more memory controllers 208-1, 208-2, . . . , 208-N, and one or more groups of memory chips 210-1, 210-2, . . . , 210-N. The SSD device 118C further includes lines 406-1, 406-2, . . . , 406-N, 407-1, 407-2, . . . , 407-N, 209-1, 209-2, . . . , 209-N.

The PCIe switches 404-1, 404-2 can each be configured to provide connections of the PCIe ports 405-1, 405-2 selectively to the plurality of memory controllers 208-1, 208-2, . . . , 208-N. For example, the illustrated PCIe switch 404-1 is operatively coupled to the PCIe port 405-1 at a first side to receive and/or provide signals (e.g., PCIe signals), and is operatively coupled to the memory controllers 208-1, 208-2, . . . , 208-N at a second side via lines 406-1, 406-2, . . . , 406-N to provide or receive signals (e.g., PCIe signals). Furthermore, the illustrated PCIe switch 404-2 is operatively coupled to the PCIe port 405-2 at a first side to receive and/or provide signals (e.g., PCIe signals), and is operatively coupled to the memory controllers 208-1, 208-2, . . . , 208-N at a second side via lines 407-1, 407-2, . . . , 407-N to provide or receive signals (e.g., PCIe signals). The PCIe ports 405-1, 405-2 can correspond to PCIe Third Generation signals. For example, in the illustrated example embodiment, the PCIe port 405-1 can correspond to two lanes of a PCIe Third Generation signals, and similarly, the PCIe port 405-2 can correspond two lanes of to a PCIe Third Generation signals.

During operation, each of the PCIe switchs 404-1, 404-2 can be configured to connect a respective port (e.g., the first port formed by the SAS port 205-1 and corresponding to PCIe switch 404-1, and the second port formed by the SAS port 205-2 and corresponding to PCIe switch 404-2) to a selected controller of a plurality of memory controllers (e.g., a selected one of the memory controllers 208-1, 208-2, . . . , 208-N) for communicating signals. Each of the PCIe switchs 404-1, 404-2 can determine the selection of the memory controller based on the respective signals of the SAS ports 205-1, 205-2. In one example embodiment, the PCIe switches 404-1, 404-2 can activate the selected memory controller to perform the read and/or write operations.

The illustrated memory controllers 208-1, . . . , 208-N can support dual port PCIe. For example, each controller of the illustrated the memory controllers 208-1, . . . , 208-N can receive a first PCIe input from the first PCIe switch 404-1 and a second PCIe input from the second PCIe switch 304-2. One advantage, among others, of some example embodiments is that including two or more PCIe switches 404-1, 404-2 can increase robustness to failures. Total drive failure due to a PCIe switch failure can mitigated if the memory controllers 208-1, . . . , 208-N support dual port PCIe. In such a case, two switches 404-1, 404-2 can be used, as shown to offer two independent paths to the memory controllers 208-1, . . . , 208-N as shown in FIG. 4.

### Layouts of Example Embodiments

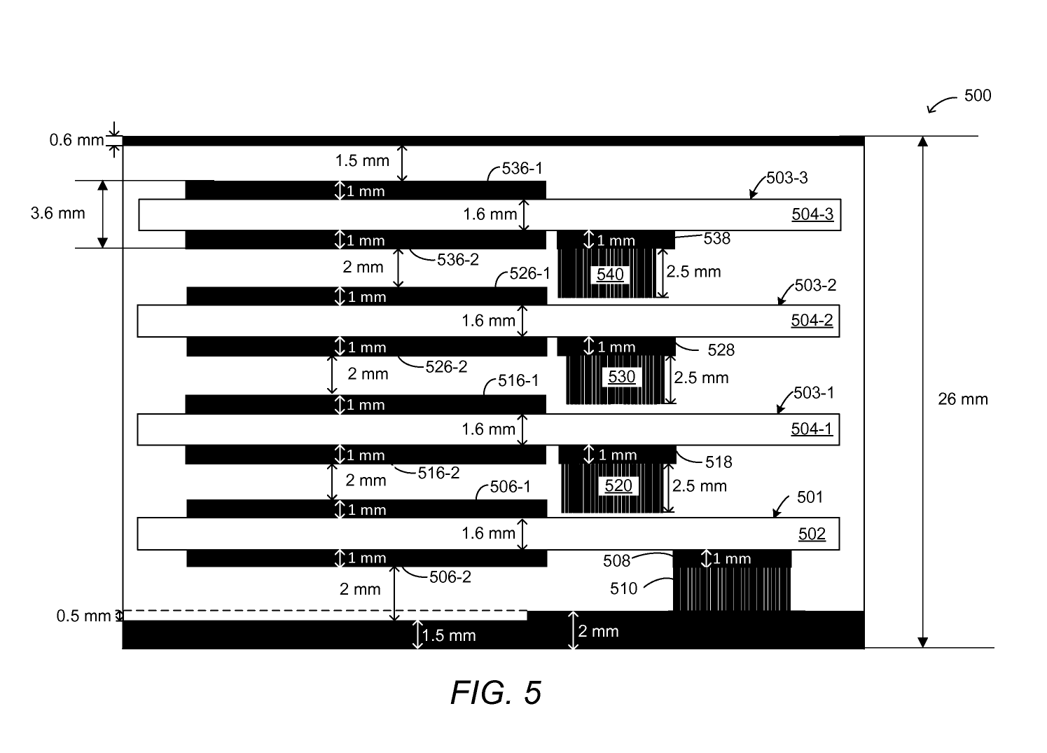

FIG. 5 is a schematic layout diagram of an SSD device 500, in accordance with an example embodiment, that may be included in the system 100 of FIG. 1. The SSD device 500 can correspond to one or more of the SSD devices 118A, 118B, 118C of FIGS. 2-4. In the illustrated example embodiment, the SSD device 500 includes a master or parent printed circuit board (PCB) (“parent board” or “parent PCB”) 501 and slave or daughter PCBs (“daughter board” or “daughter PCB”) 503-1, 503-2, 503-3. The parent PCB 501 includes a board 502, a first side of memory chips 506-1, a second side of memory chips 506-2, control circuitry 508, and a heat sink 510. Each of the daughter PCBs 503-1, 503-2, 503-3 includes respective boards 504-1, 504-2, 504-3, first sides of memory chips 516-1, 526-1, 536-1, second sides of memory chips 516-2, 526-2, 536-2, control circuitries 518, 528, 538, and heat sinks 520, 530, 540. It will be appreciated that not all elements of the SSD device 500 are necessarily shown for the sake of brevity. It will also be appreciated the SSD device 500 can include additional or fewer daughter PCBs 503-1, 503-2, 503-3 to create multiple product configurations and/or to address applications that need higher and/or lower write ratios and consequently need higher and/or lower power. While various elements of the example embodiment of FIG. 5 are described as having certain dimensions and sizes, it will be understood that the disclosed dimensions and sizes are provided as non-limiting examples, and alternative example embodiments having different dimensions and sizes are contemplated.

The control circuitry 508 of the parent PCB 501 can correspond to the SAS expander(s) 204, 304-1, 304-2, and one or more of the memory controllers 208-1, 208-2, . . . , 208-N of FIGS. 2 and 3, or the PCIe switch(es) 404-1, 404-2 and one or more of the memory controllers 208-1, 208-2, . . . , 208-N of FIG. 4. The control circuitries 518, 528, 538 of the daughter PCBs 503-1, 503-2, 503-3 can correspond to a number of the memory controllers 208-1, 208-2, . . . , 208-N of FIGS. 2-4. The first and second sides of memories 506-1, 506-2, 516-1, 516-2, 526-1, 526-2, 536-1, 536-2 can correspond to a number of the memory chips 210-1, 210-2, . . . , 210-N of FIGS. 2-4.

The heat sink 510 can be operatively coupled to the control circuitry 508 to dissipate heat generated by the control circuitry 508. In addition, the heat sink 510 can be operatively coupled to the drive body 202 such that the heat sink can configured to dissipate heat generated by the control circuitry 508 by transferring heat through to the drive body 202. Coupling the heat sink 510 can aid in heat dissipation and can allow for including an increased number of memory chips (e.g., by allowing the use of the increased number of memory chips while meeting the thermal budget).

In the illustrated example embodiment, each of the boards 502, 504-1, 504-2, 504-3 can be about 1.6 mm thick, as shown in FIG. 5. Furthermore, each side of the memories 506-1, 506-2, 516-1, 516-2, 526-1, 526-2, 536-1, 536-2 can be about 1 mm thick. There can be about 2 mm space between the sides of the memory of adjacent PCB boards 501, 503-1, 503-2, 503-3 for air flow. Moreover, the illustrated example embodiment includes about 1.5 mm space between the side of the memory 536-1 of the PCB board 503-3 facing the drive body 202 and the respective wall of the drive body 202 (e.g., the “top plate” of the drive body 202) for airflow. The top plate of the drive body 202 can be about 0.6 mm thick for airflow. In addition, the opposite side (e.g., the “bottom plate”) of the drive body 202 can have a first portion that is about 1.5 mm thick and a second portion that is about 2 mm thick to define a cavity. The first portion can be spaced about 2 mm away from the side of memory 506-2. The second portion can be thermally coupled to the heat sink 510. The bottom plate with the cavity as described above can serve to provide additional space to facilitate airflow and additional material to couple with the heat sink 510 for heat dissipation. The heat sinks 520, 530, 540 can be about 2.5 mm wide, as shown, for heat dissipation. Accordingly, the drive body 202 can have a width of about 26 mm, as shown in FIG. 5. The above-described spacing that is illustrated in FIG. 5 can provide a substantial data storage density that meets the thermal constraints in accordance with Big Data storage access.

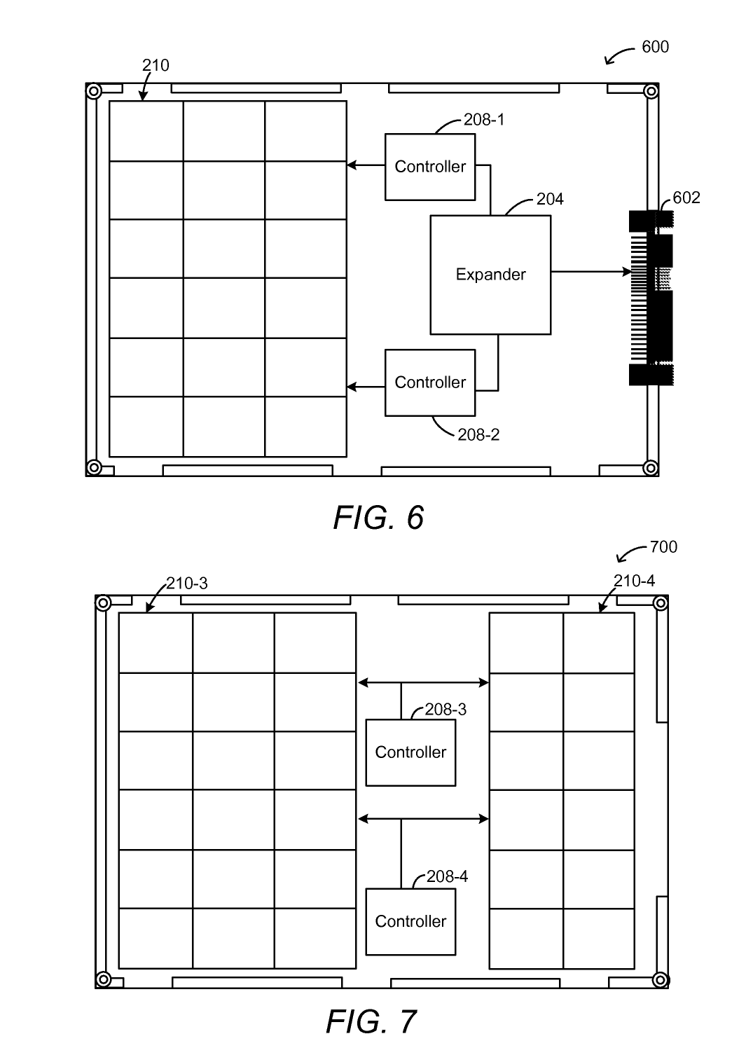

FIG. 6 is a schematic layout diagram of a parent board 600, in accordance with an example embodiment, of an SSD device. The parent board can correspond to the parent board 501 of FIG. 5. The SSD device can correspond to the SSD device 118B of FIG. 3. Elements common to FIGS. 3, 5, and 6 share common reference indicia, and only differences between the Figures are described herein for the sake of brevity. Additionally, not all elements are necessarily shown in the Figures for the sake of brevity.

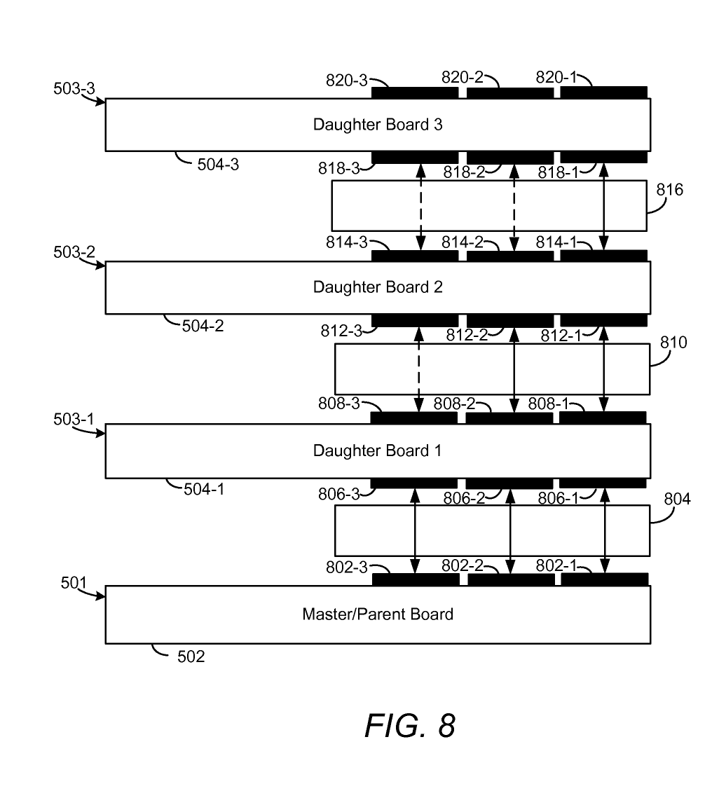

The parent board 600 comprises a SAS expander 204, memory controllers 208-1, 208-2, memory chips 210, and connector 602. The connector 602 can provide an external interface for communicating with an external host device (not shown), such as an SAS controller in a server. The connector 602 is operatively coupled to the SAS expander 204. The SAS expander is operatively coupled to the memory controllers 208-1, 208-2. In turn, the memory controllers 208-1, 208-2 are operatively coupled to the memory chips 210. As will be described later in greater detail in connection with FIG. 8, the SAS expander can be operatively coupled to memory controllers of the daughter boards 503-1, 503-2, 503-2 shown in FIG. 5.

FIG. 6 shows one side of the parent board 600. The illustrated side shows 18 memory chips included in the memory chips 210. In one example embodiment, the memory chips 210 can each correspond to 128 GB multi-level cell (MLC) NAND technology. Accordingly, the side shown by FIG. 6 can provide about 2 TB of data storage. Additionally, the opposite side (not shown) of the parent board can include an additional 18 memory chips for providing an additional 2 TB of data storage. Accordingly, the parent board 600 can provide about 4 TB of data storage.

FIG. 7 is a schematic layout diagram of a daughter board 700, in accordance with an example embodiment, of an SSD device. The daughter board 700 can correspond to the daughter boards 503-1, 503-2, 503-3 of FIG. 5 of the SSD devices 118A, 118B, 118C of FIGS. 2-4. Elements common to FIGS. 2-4 and 7 share common reference indicia, and only differences between the Figures are described herein for the sake of brevity. Additionally, not all elements are necessarily shown in the Figures for the sake of brevity.

The daughter board 700 of FIG. 7 comprises memory controllers 208-3, 208-4, memory chips 210-3, 210-4. As will be described in greater detail below in connection with FIG. 8, the memory controller 208-3, 208-4 can be configured to receive signals (e.g., SAS and/or SATA) from a parent board, such as the parent board 501 of FIG. 6. In turn, the memory controllers 208-3, 208-4 are operatively coupled to the memory chips 210-3. Accordingly, the daughter board 700 can be configured to provide data storage access. In particular, the daughter board 700 can be configured to provide a parent board access to the data storage of the memory chips 210-3.

FIG. 7 shows one side of the daughter board 700. The illustrated side shows 30 memory chips of the memory chips 210-3, 210-4. In one example embodiment, the memory chips 210-3, 210-4 can each correspond to 128 GB MLC NAND flash technology. Accordingly, the side shown by FIG. 7 can provide about 3.84 TB of data storage. Additionally, the opposite side (not shown) of the parent board can include another 30 memory chips for providing an additional 3.84 TB of data storage. Accordingly, the daughter board 501 can provide about 7.68 TB of data storage.

FIG. 8 is a schematic block diagram illustrating an example embodiment of signal connections between the parent board 501 and the daughter boards 503-1, 503-2, 503-3 of the SSD device 500 of FIG. 5. Elements common to FIGS. 5 and 8 share common reference indicia, and only differences between the Figures are described herein for the sake of brevity. Additionally, not all elements are necessarily shown in the Figures for the sake of brevity.

The parent board 501 and the daughter boards 503-1, 503-2, 503-3 can be interconnected and configured to provide communication of data and control signals and power. For example, the boards 501, 503-1, 503-2, 503-3 can be connected using a mezzanine connection. In the illustrated example embodiment, the parent board 501 can include nodes 802-1, 802-2, 802-3 operatively coupled to a first end of a connector 804. On a second end, the connector 804 can be operatively coupled to nodes 806-1, 806-2, 806-3 of the daughter card 503-1. The daughter board 503-1 can further include nodes 808-1, 808-2, 808-2 operatively coupled to a first end of a connector 810. On a second end, the connector 810 can be operatively coupled to nodes 812-1, 812-2, 812-3 of the daughter card 503-2. The daughter board 503-2 can further include nodes 814-1, 814-2, 814-2 operatively coupled to a first end of a connector 816. On a second end, the connector 816 can be operatively coupled to nodes 818-1, 818-2, 818-3 of the daughter card 503-3. The daughter board 503-3 can further include nodes 820-1, 820-2, 820-2 for operatively coupling to another connector (not shown) for including additional daughter boards (not shown), or left unconnected.

In operation, signals may be carried between the parent board 501 and the daughter boards 503-1, 503-2, 503-3. For example, a SAS expander (e.g., SAS expander 204 of FIG. 2) can access memory controllers (e.g., one or more of the memory controller 208-1, 208-2, . . . , 208-N of FIG. 2) of the daughter boards 503-1, 503-2, 503-3. In this way, a host device interconnected with the parent board 501 can utilize data storage provided by the daughter boards 503-1, 503-2, 503-3.

In operation, signals can be carried bi-directionally between the parent board 501 and the first daughter board 503-1 via the node 802-1, the connector 804, and the node 806-1. Additionally, signals can be carried bi-directionally between the parent board 501 and the second daughter board 503-2 via a path formed by the node 802-2, the connector 804, the node 806-2, the node 808-1, the connector 810, and the node 812-1. Additionally, signals can be carried bi-directionally between the parent board 501 and the third daughter board 503-3 via a path formed by the node 802-3, the connector 804, the node 806-3, the node 808-2, the connector 810, the node 812-2, the node 814-1, the connector 816, and the node 8181-1. Additionally, one or more of the nodes of the boards can be left unused, or used for other functionality. For example, one or more of the nodes 808-3, 814-2, 814-3, 818-2, 818-3, 820-1, 820-2, 820-3 may or may not be used, as indicated by the dashed arrow. It will be appreciated that other line routing designs suitable for interconnecting the parent board 501 and the daughter boards 503-1, 503-2, 503-3 can be used in alternative example embodiments.

### Modules, Components and Logic

Embodiments described above can be implemented using hardware or software, including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A device comprising:
a plurality of solid state memory devices;
a plurality of memory controllers operatively coupled to the plurality of solid state memory devices, the plurality of memory controllers being configured to access data stored by the plurality of solid state memory devices;
a first selection circuit operatively coupled to the plurality of memory controllers, the first selection circuit configured to activate each of the plurality of memory controllers selectively; and
a drive body including the plurality of solid state memory devices, the plurality of memory controllers, and the first selection circuit, the drive body including an interface operatively coupled to the selection circuit, the interface being configured to receive signals, the first selection circuit being configured to activate a selected memory controller of the plurality of memory controllers based at least partly on the received signal.

2. The device of claim 1, wherein the drive body corresponds to a large form factor drive body, the plurality of solid state memory devices having a combined data storage capacity greater than about 2 terabytes.

3. The device of claim 1, wherein the first selection circuit includes at least one SAS expander circuit, the interface corresponding to at least one of a SAS data port or a SATA data port.

4. The device of claim 1, wherein the selection circuit includes at least one PCIe switch circuit, the interface corresponding to at least one PCIe data port.

5. The device of claim 1, further comprising:
a first circuit board communicatively coupled to the interface, the first circuit board including the first selection circuit, at least one of the plurality of memory controllers, and at least a portion of the plurality of solid state memory devices.

6. The device of claim 5, further comprising:
a second circuit board including at least one of the plurality of memory controllers and at least a portion of the plurality of memory devices, the second circuit board communicatively coupled to the first circuit board such that the first selection circuit coupleable with the at least one memory controller of the second circuit board to access the solid state memory devices of the second circuit board.

7. The device of claim 5, further comprising a heat sink device coupled to the first selection circuit, wherein the heat sink physically contacts the drive body.

8. The device of claim 1, wherein the first selection circuit is configured to provide a failure signal at the interface based on a detected failure of at least one of the plurality of solid state memory devices, the first selection circuit being further configured to provide a failure signal at the interface based on a detected failure of at least one of the plurality of memory controllers.

9. The device of claim 1, further comprising:
a second selection circuit operatively coupled to the plurality of memory controllers, the second selection circuit configured to activate each of the plurality of memory controllers selectively;
first and second ports of the interface, the first selection circuit being operatively coupled to the first port, the second selection circuit being operatively coupled to the second port, the first selection circuit being configured to activate a selected memory controller of the plurality of memory controllers based at least partly on received signals at the first port, the second selection circuit being configured to activate a selected memory controller of the plurality of memory controllers based at least partly on received signals at the second port.

10. The device of claim 1, wherein the plurality of memory controllers are each configured to sense a temperature of the respective memory controllers.

11. The device of claim 1, wherein each of the plurality of memory controllers is configured to determine a temperature of at least one of the plurality of memory devices, the temperature being determined based at least on a number of data accesses to the at least one of the plurality of memory devices.

12. The device of claim 1, wherein the activating the selected memory controller corresponds to at least one of reading or writing to the corresponding solid state memory device.

13. A device for data storage, the device comprising:
a plurality of solid state memory devices;
a plurality of means for accessing data stored by the plurality of solid state memory devices;
means for selectively activating each of the plurality of accessing means;
means for receiving signals, the activating means being configured to activate a selected one of the plurality of activating means based at least partly on the received signal; and
means for housing the plurality of solid state memory devices, the plurality of accessing means, the activating means, and the interfacing means, the housing means being configured to provide the receiving means to interface with external circuitry.

14. A system comprising:
a server device;
a first data storage device communicatively coupled to the server device, the first data storage device comprising one or more disk drives;
a second data storage communicatively coupled to the server device, the second data storage device having a greater storage capacity than the first data storage device, the second data storage device comprising at least one disk drive including:
a plurality of solid state memory devices;
a plurality of memory controllers operatively coupled to the plurality of solid state memory devices, the plurality of memory controllers being configured to access data stored by the plurality of solid state memory devices;
a first selection circuit operatively coupled to the plurality of memory controllers, the first selection circuit configured to activate each of the plurality of memory controllers selectively; and
a drive body including the plurality of solid state memory devices, the plurality of memory controllers, and the first selection circuit, the drive body including an interface operatively coupled to the selection circuit, the interface being configured to receive signals, the first selection circuit being configured to activate a selected memory controller of the plurality of memory controllers based at least partly on the received signal.

15. The system of claim 13, wherein the serve device is configured to store data of a first type in the first data storage device and store data of a second type in the second data storage device.

16. The system of claim 13, wherein the drive body corresponds to a large form factor drive body, the plurality of solid state memory devices having a total data storage capacity greater than about 2 terabytes.

17. The system of claim 13, wherein the selection circuit includes at least one SAS expander circuit, the interface corresponding to at least one of a SAS port or a SATA port.

18. The system of claim 13, wherein the selection circuit includes at least one PCIe switch circuit, the interface corresponding to at least one PCIe port.

19. The system of claim 13, further comprising: a first circuit board communicatively coupled to the interface, the first circuit board including the first selection circuit, at least one of the plurality of memory controllers, and at least a portion of the plurality of solid state memory devices.

20. The system of claim 18, further comprising:
a second circuit board including at least one of the plurality of memory controllers and at least a portion of the plurality of memory devices, the second circuit board communicatively coupled to the first circuit board such that the first selection circuit coupleable with the at least one memory controller of the second circuit board to access the solid state memory devices of the second circuit board.

21. The system of claim 18, further comprising a heat sink device coupled to the first selection circuit, wherein the heat sink physically contacts the drive body.
